(19) United States
(12) Patent Application Publication
(10) Pub. No.: US 2016/0350537 A1
(43) Pub. Date: Dec. 1, 2016

(54) CENTRAL PROCESSING UNIT AND METHOD TO VERIFY MAINBOARD DATA

(71) Applicant: VIA Alliance Semiconductor Co., Ltd., Shanghai (CN)

(72) Inventors: Zhenhua HUANG, Beijing (CN); Yong LI, Beijing (CN); Mengmeng YAN, Beijing (CN); Xuehua HAN, Beijing (CN)

(21) Appl. No.: 15/098,471

(22) Filed: Apr. 14, 2016

(30) Foreign Application Priority Data
May 25, 2015 (CN) 201510272794.1

(51) Int. Cl. G06F 21/57; H04L 9/32; G06F 21/64

(52) U.S. Cl. CPC G06F 21/575; G06F 21/64; H04L 9/3247; G06F 2221/034

(57) ABSTRACT

Provided is a Central Processing Unit (CPU) and a method to verify mainboard data. The CPU comprises: an on-die Read-Only Memory (ROM) for storing trusted root digest information, wherein the trusted root digest information is not allowed to be modified; and a core for, during a power-up process, computing digest information of a trusted root data stored in a mainboard using a digest algorithm, comparing the digest information with the trusted root digest information, and performing a signature verification algorithm with the trusted root data to verify the integrity of mainboard data if the digest information coincides with the trusted root digest information.

### BACKGROUND

The present invention relates to computer systems, and particularly, to a Central Processing Unit (CPU) capable of verifying mainboard data and a method to verify mainboard data.

Recently, computer systems are widely applied in various fields. Due to the popularity of information networks, security issues of computer system are increasingly cared about. Malicious application programs spread over network may cause loss of a user by stealing, tampering, erasing data stored in a computer system.

Once powered up, a computer system performs an initial booting and initializing procedure based on system initialization instructions stored in a Read-Only Memory (ROM) on the mainboard, such as the Basic Input Output System (BIOS) or Extensible Firmware Interface (EFI). During the power-up process, other data also may be required to be read from the mainboard, for example, a microcode (ucode) patch is read from the mainboard to update the ucode in the CPU.

In order to secure the data stored in the mainboard (e.g., the aforesaid system initialization instructions or ucode patch, etc), the integrity of the data may be verified by a digital signature algorithm based on an asymmetric encryption/decryption algorithm. In the case of cascaded verification, the security of the digital signature verification relies on the trusted root eventually. If a trusted root of a computer system is maliciously modified, the security measures in other levels are crippled. Accordingly, the integrity of the system trusted root is the basis to ensure the security of the entire computer system.

The trusted root data (e.g., 2048-bit RSA public key) may be stored in a separate Trusted Platform Module (TPM) chip, which incurs additional cost of hardware. On the other hand, suppose the trusted root data is stored in mainboard ROM, the trusted root established in this way cannot guarantee the security of the computer system because the mainboard data itself may be maliciously modified.

### SUMMARY

Accordingly, in order to solve the above problems, the present invention provides a CPU capable of verifying mainboard data and a method to verify mainboard data.

According to an aspect of an embodiment of the present invention, provided is a Central Processing Unit (CPU), comprises: an on-die Read-Only Memory (ROM) for storing trusted root digest information, wherein the trusted root digest information is not allowed to be modified; and a core for, during a power-up process, computing digest information of a trusted root data stored in a mainboard using a digest algorithm, comparing the digest information with the trusted root digest information, and performing a signature verification algorithm with the trusted root data to verify the integrity of mainboard data if the digest information coincides with the trusted root digest information.

According to an embodiment of the present invention, the on-die ROM may comprise a plurality of fuses for burning candidate trusted root digest information with different priority levels, respectively, and the core may adopts a candidate trusted root digest information with a highest priority level burnt in the fuses as the trusted root digest information.

According to an embodiment of the present invention, the signature verification algorithm may be based on an asymmetric encryption/decryption algorithm, the mainboard data may be encrypted with a private key based on the asymmetric encryption/decryption algorithm, and the trusted root data may comprise a public key corresponding to the private key.

According to an embodiment of the present invention, the core may comprise a hardware circuit for performing the digest algorithm.

According to an embodiment of the present invention, the CPU may further store digest instructions, and the core may perform the digest algorithm by executing the digest instructions.

According to an embodiment of the present invention, the core may comprise a hardware circuit for performing the signature verification algorithm.

According to an embodiment of the present invention, the CPU may further store signature verification instructions, and the core may perform the signature verification algorithm by executing the signature verification instructions.

According to an embodiment of the present invention, the mainboard data may comprise a ucode patch of the CPU, and the core computes the digest information once a specific instruction is received during the power-up process.

According to an aspect of an embodiment of the present invention, provided is a method to verify mainboard data, comprises: reading a trusted root data from a mainboard during a power-up process; computing digest information of the trusted root data using a digest algorithm; comparing the digest information with trusted root digest information stored in an on-die Read-Only Memory (ROM) of a Central Processing Unit (CPU), wherein the trusted root digest information is not allowed to be modified; reading mainboard data from the mainboard if the digest information coincides with the trusted root digest information; and performing a signature verification algorithm with the trusted root data to verify the integrity of the mainboard data.

According to an embodiment of the present invention, the on-die ROM may comprise a plurality of fuses for burning candidate trusted root digest information with different priority levels, respectively, and the method may further comprise: adopting a candidate trusted root digest information with a highest priority level burnt in the fuses as the trusted root digest information.

According to an embodiment of the present invention, the signature verification algorithm may be based on an asymmetric encryption/decryption algorithm, the mainboard data may be encrypted with a private key based on the asymmetric encryption/decryption algorithm, and the trusted root data may comprise a public key corresponding to the private key.

According to an embodiment of the present invention, the digest algorithm may be performed by a hardware circuit in the CPU.

According to an embodiment of the present invention, the digest algorithm may be performed by executing digest instructions stored in the CPU.

According to an embodiment of the present invention, the signature verification algorithm may be performed by a hardware circuit in the CPU.

According to an embodiment of the present invention, the signature verification algorithm may be performed by executing signature verification instructions stored in the CPU.

According to an embodiment of the present invention, the mainboard data may comprise a ucode patch of the CPU, and the aforesaid step of reading the trusted root data from the mainboard is performed once a specific instruction is received during the power-up process.

By using the CPU and the method to verify mainboard data according to the present invention, on the one hand, the security of the system is significantly improved by a system trusted root established in an on-die ROM inside the CPU; on the other hand, since what is stored in the on-die ROM is just trusted root digest information with smaller size instead of the entire trusted root data, the limited storage space may be saved, resulting in a cut in cost of hardware.

### BRIEF DESCRIPTION OF THE DRAWINGS

FIG. 1 illustrates a computer system 100 comprising a CPU 102 according to an embodiment of the present invention;

FIG. 2 illustrates the CPU 102 according to another embodiment of the present invention;

FIG. 3 illustrates the on-die ROM 201 in the CPU 102 of FIG. 2 according to another embodiment of the present invention;

FIG. 4 illustrates the BIOS ROM 111 in the mainboard 101 of FIG. 1 according to another embodiment of the present invention; and

FIG. 5 is a flowchart diagram of a method to verify mainboard data according to an embodiment of the present invention.

### DETAILED DESCRIPTION

Hereinafter, various exemplary embodiments of the present invention will be described in detail with reference to the drawings. Like or similar reference numerals are designated to constituent parts with substantially same structures and functions, and redundant descriptions for substantially same constituent parts are omitted for the conciseness of the specification.

FIG. 1 illustrates a computer system 100 comprising a CPU 102 according to an embodiment of the present invention.

Referring to FIG. 1, the computer system 100 comprises a mainboard 101, the CPU 102, an Input/Output (I/O) device 103, and a memory device 104. The mainboard 101 comprises a BIOS ROM 111 and a Random Access Memory (RAM) 112. It is to be noted that, while BIOS is illustrated here as the system initialization instructions by way of example, computer systems using other technologies of system initialization instructions (e.g., EFI) also fall into the scope of the present invention.

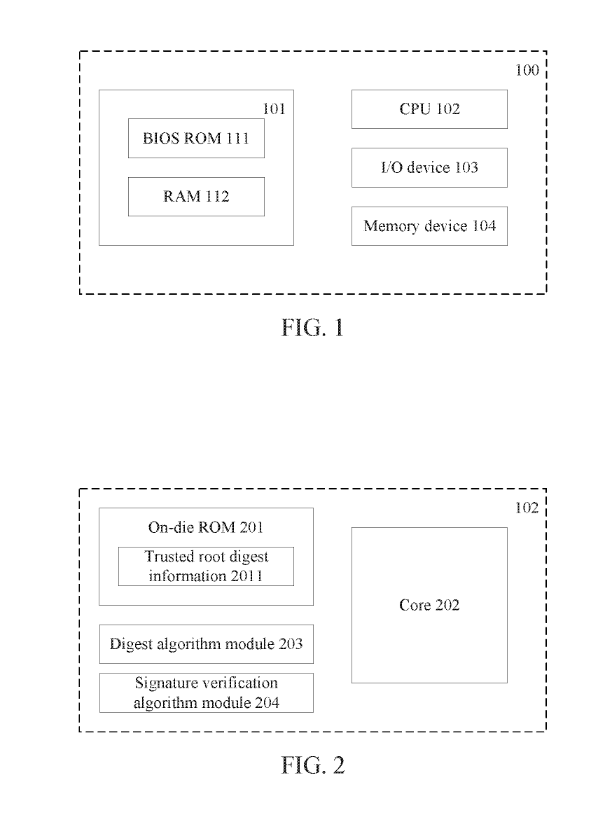

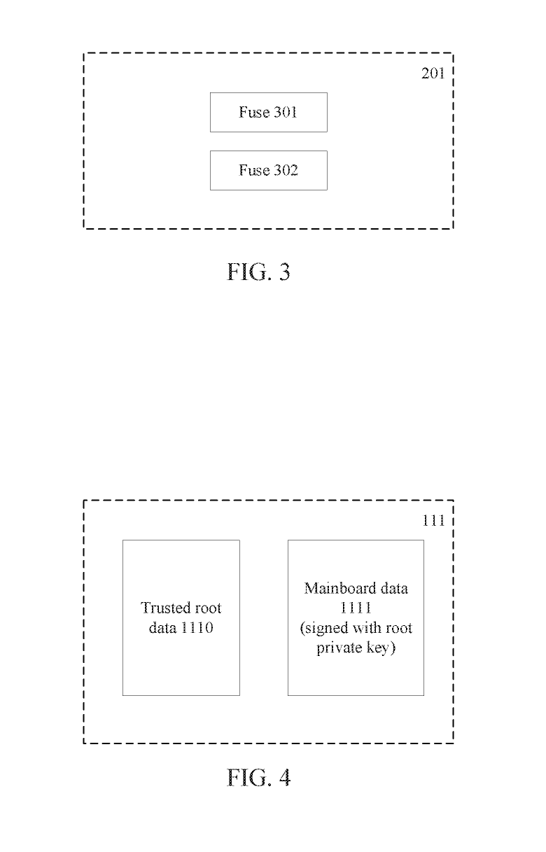

FIG. 2 illustrates the CPU 102 according to another embodiment of the present invention.

Referring to FIG. 2, the CPU 102 comprises an on-die ROM 201 and a core 202. Here, the on-die ROM 201 is for storing trusted root digest information 2011, which is not allowed to be modified. The core 202 is for, when the computer system 100 is powered up, computing digest information of a trusted root data stored in the mainboard 101 using a digest algorithm; the core 202 compares the computed digest information with the trusted root digest information 2011 in the on-die ROM 201 to verify the integrity of the trusted root data. If the digest information is inconsistent with the trusted root digest information 2011, which indicates that the trusted root data in the mainboard has been tampered, the verification fails.

If the digest information coincides with the trusted root digest information 2011, a signature verification algorithm is performed with the trusted root data to verify the integrity of mainboard data. According to an embodiment of the present invention, the mainboard data may comprise a ucode patch for updating the ucode of the CPU 102. However, the present invention is not limited thereto. In other embodiments, the mainboard data may be system initialization instructions of the mainboard 101, e.g., BIOS code or EFI code.

In an embodiment, the on-die ROM 201 may be a on-die ROM in the CPU 201, the contents of which are preset in the chip manufacture process of the CPU 201 and cannot be modified, so that the trusted root digest information 2011 stored therein in advance is protected from tampering, thus qualified as a trusted root for the entire computer system 100. On the one hand, in the present invention, the security of the system is significantly improved by using the on-die ROM 201 internal to the CPU 201 as the system trusted root; on the other hand, since what is stored in the on-die ROM 201 is just trusted root digest information with smaller size instead of the entire trusted root data, the limited storage space may be saved.

According to an embodiment of the present invention, the CPU 102 may further comprise a digest algorithm module 203 and a signature verification algorithm module 204 implementing the digest algorithm and the signature verification algorithm, respectively. In an embodiment, the digest algorithm module 203 may be implemented in the form of digest instructions, and/or the signature verification algorithm module 204 may be implemented in the form of signature verification instructions. The core 202 performs the digest algorithm by executing the digest instructions, and/or performs the signature verification algorithm by executing the signature verification instructions. In such an embodiment, the digest algorithm module 203 and/or the signature verification algorithm module 204 need to occupy additional storage space in the CPU 102 to store the digest instructions and/or the signature verification instructions, but the present invention is not limited thereto. In another embodiment, the digest algorithm module 203 and/or the signature verification algorithm module 204 may be implemented with a hardware circuit, which may be included in the core 202. In this case, the CPU 102 has no need to store the digest instructions and/or the signature verification instructions, so that storage space may be further saved. As the manufacture cost of the CPU 102 significantly rises with an increase in the capacity of the on-die ROM 201, the present invention may further reduce the manufacture cost of the CPU 102.

FIG. 3 illustrates the on-die ROM 201 in the CPU 102 of FIG. 2 according to another embodiment of the present invention. According to an embodiment of the present invention, the on-die ROM 201 may comprises a fuse 301 and a fuse 302 for burning two pieces of candidate trusted root digest information. Here, the candidate trusted root digest information burnt in the fuse 302 has a priority level higher than that of the candidate trusted root digest information burnt in the fuse 301. The core 202 uses the candidate trusted root digest information burnt in the fuse 301 as the trusted root digest information only if the fuse 302 has not been burnt.

While the on-die ROM 201 in FIG. 3 comprises only two fuses, the present invention is not limited thereto. According to an embodiment of the present invention, the on-die ROM 201 may comprises a plurality of fuses for burning candidate trusted root digest information with different priority levels, respectively, and the core 202 may adopt a candidate trusted root digest information with the highest priority level burnt in the fuses as the trusted root digest information.

By providing a plurality of fuses for burning candidate trusted root digest information in the on-die ROM 201 in the CPU 102, the trusted root digest information may be overwritten according to the requirement after production, thereby flexibility is provided. For example, when a private key corresponding to a public key acting as the existing trusted root data is inadvertently leaked, since it has to be replaced with new trusted root data, the corresponding new trusted root digest information can be updated by overwriting.

FIG. 4 illustrates the BIOS ROM 111 in the mainboard 101 of FIG. 1 according to another embodiment of the present invention.

Referring to FIG. 4, by way of example, an asymmetric encryption/decryption algorithm (e.g., RSA signature verification algorithm) is used as the signature verification algorithm to verify the mainboard data. In this case, a trusted root data 1110 is stored in the BIOS ROM 111. In an embodiment, the trusted root data 1110 is a root public key of the aforesaid signature verification algorithm (hereinafter, referred to as the root public key). Further stored in the BIOS ROM 111 is a mainboard data 1111, a non-limiting example of which is a ucode patch for updating the ucode of the CPU. Here, the ucode patch is signed with a root private key corresponding to the above root public key (hereinafter, referred to as the root private key). In other embodiments, the mainboard data 1111 may also be system initialization instructions of the mainboard 101, e.g., BIOS code or EFI code. Also, the system initialization instructions are signed with the root private key corresponding to the above root public key. The following embodiments are described with the trusted root data 1110 being the root private key and the mainboard data 1111 being the ucode patch.

During the power-up process of the computer system 100, when a specific instruction (e.g., 0×79) is received by the core 202, the core 202 controls the digest algorithm module 203 to perform a digest algorithm (e.g., a secure hash algorithm) to compute digest information of the root public key (i.e., the trusted root data 1110) stored in the BIOS ROM 111 or other memory devices. With the secure hash algorithm SHA-1 being the digest algorithm by way of example, the core 202 reads the code of the root public key stored in the BIOS ROM 111 or other memory devices and performs hash operation on it to generate the digest information, the specific procedure of which will be herein omitted. The amount of data of the digest information generated using different hash algorithms (e.g., SHA-2, SHA-128, or SHA-256 etc) may vary. Naturally, the usage of other digest algorithms also falls into the protection scope of the present invention.

The core 202 compares the computed digest information with the trusted root digest information 2011 stored in the on-die ROM 201. Since a digest algorithm uses the root public key (i.e., the trusted root data 1110) with arbitrary length as the originator and outputs digest information with fixed length, the digest information will be different for different root public keys acting as the originator. Therefore, if the computed digest information is inconsistent with the trusted root digest information 2011, it means that the root public key stored in the BIOS ROM 111 has been tampered, thereby the verification fails; if the computed digest information coincides with the trusted root digest information 2011, it means that the root public key is not tampered, thus the core 202 further controls the signature verification algorithm module 204 to perform a signature verification algorithm to verify the integrity of the ucode patch (i.e., the mainboard data 1111) and the verification fails if the ucode patch cannot pass the integrity verification, that is, it is further determined if the ucode patch is tampered.

In the above embodiments, a private key of an asymmetric encryption/decryption algorithm is used to sign the ucode patch (i.e., the mainboard data 1111) and a corresponding public key is used to verify its integrity. However, the present invention is not limited thereto, according to an embodiment of the present invention, other types of signature verification algorithms may be used to verify the integrity of the mainboard data. In this case, rather than the root public key, other trusted root data 1110 is stored in the BIOS ROM 111 for verifying corresponding signature verification algorithms instead.

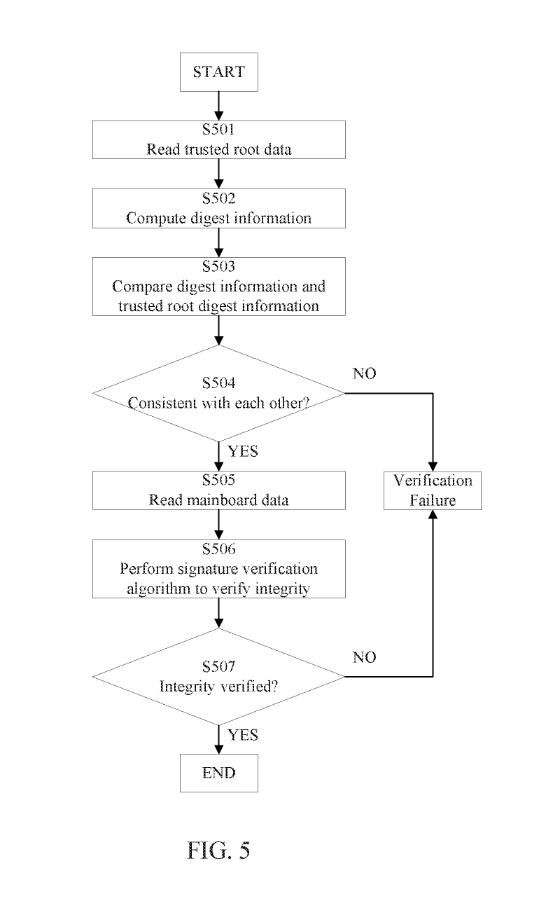

FIG. 5 is a flowchart diagram of a method to verify mainboard data according to an embodiment of the present invention.

Referring to FIG. 5, in step S501, during the power-up process of the computer, a trusted root data is read from the mainboard. The trusted root data may be stored in the BIOS ROM of the mainboard to establish a trusted root of the computer system 100 for integrity verification of mainboard data.

In step S502, digest information of the trusted root data is computed using a digest algorithm. According to an embodiment of the present invention, the digest algorithm may comprise secure hash algorithms SHA-1, SHA-2, or SHA-256 etc. As previously mentioned, the digest algorithm may be performed by digest instructions stored in the CPU, the digest algorithm may also be performed by a hardware circuit included in the core of the CPU.

In step S503, the computed digest information is compared with trusted root digest information stored in the on-die ROM of the CPU to verify the integrity of the trusted root data. Here, the trusted root digest information is not allowed to be modified.

If the digest information is inconsistent with the trusted root digest information (“NO” in S504), the verification fails. If the digest information coincides with the trusted root digest information (“YES” in S504), in step S505, the mainboard data, e.g., a ucode patch for updating the ucode of the CPU, is read from the mainboard. The mainboard data may be stored in the BIOS ROM.

In step S506, a signature verification algorithm is performed with the verified trusted root data (e.g., the verified root public key of the signature verification algorithm) to verify the integrity of the mainboard data. If the mainboard data cannot pass the integrity verification (“NO” in S507), the verification fails. If the mainboard data passes the integrity verification (“YES” in S507), the verification is successful. As previously mentioned, the signature verification algorithm may be performed by signature verification instructions stored in the CPU, the signature verification algorithm may also be performed by a hardware circuit included in the core of the CPU. Only after being successfully verified, can the mainboard data be normally loaded: in an embodiment where the mainboard data being ucode patch, only upon a successful verification, a normal loading procedure of the ucode patch is started, that is, a decryption (e.g., Advanced Encryption Standard decryption) operation is performed on the ucode patch starting from a ucode BIOS header address; after the decryption passes verification, the ucode BIOS header is discarded, and the ucode patch data is loaded starting from a ucode patch header address; after the ucode patch header also passes verification, the ucode patch data is loaded to the CPU to update the ucode of the CPU. If the verification fails (including the “NO” in S504 and the “NO” in S507), the ucode patch may notify the user via the system initialization program (e.g., BIOS program).

With the CPU and the method to verify mainboard data provided in the present invention, on the one hand, the mainboard data is secured by using the on-die ROM 201 internal to the CPU 102 as the system trusted root, the security level is significantly improved compared with the technique of securing the mainboard data by adding an additional security module (e.g., TPM chip); on the other hand, the present invention uses digest information to assure the integrity of the trusted root data stored in the mainboard for establishing the trusted root, therefore it is not necessary to store a considerable amount of trusted root data in the limited storage of the on-die ROM in the CPU, but to only store a small amount of trusted root digest information; with the trusted root data being a root public key of a signature verification algorithm by way of example, if the size of the root public key is 2048 bits, the corresponding trusted root digest information using the digest algorithm comprises only 256 bits. Moreover, by performing the digest algorithm and/or the signature verification algorithm with dedicated hardware circuits in the CPU core, the usage of the storage space of the CPU may be further reduced.

While various embodiments of the present invention have been described in detail as above, the present invention is not limited thereto. It is to be appreciated by those skilled in the art that various modification, combination, sub-combination or substitution may be made according to design requirements or other factors in the scope of the appended claims and their equivalents.

What is claimed is:

1. A Central Processing Unit (CPU), comprises:
an on-die Read-Only Memory (ROM) for storing trusted root digest information, wherein the trusted root digest information is not allowed to be modified; and
a core for, during a power-up process, computing digest information of a trusted root data stored in a mainboard using a digest algorithm, comparing the digest information with the trusted root digest information, and performing a signature verification algorithm with the trusted root data to verify the integrity of mainboard data if the digest information coincides with the trusted root digest information.

2. The CPU of claim 1, wherein the on-die ROM comprises a plurality of fuses for burning candidate trusted root digest information with different priority levels, respectively, and
the core adopts a candidate trusted root digest information with the highest priority level burnt in the fuses as the trusted root digest information.

3. The CPU of claim 1, wherein the signature verification algorithm is based on an asymmetric encryption/decryption algorithm, the mainboard data is encrypted with a private key based on the asymmetric encryption/decryption algorithm, and the trusted root data comprises a public key corresponding to the private key.

4. The CPU of claim 1, wherein the core comprises a hardware circuit for performing the digest algorithm.

5. The CPU of claim 1, wherein the CPU further stores digest instructions, and
the core performs the digest algorithm by executing the digest instructions.

6. The CPU of claim 1, wherein the core comprises a hardware circuit for performing the signature verification algorithm.

7. The CPU of claim 1, wherein the CPU further stores signature verification instructions, and
the core performs the signature verification algorithm by executing the signature verification instructions.

8. The CPU of claim 1, wherein the mainboard data comprises a ucode patch of the CPU, and the core computes the digest information once a specific instruction is received during the power-up process.

9. A method to verify mainboard data, comprises:
reading a trusted root data from a mainboard during a power-up process;
computing digest information of the trusted root data using a digest algorithm;
comparing the digest information with trusted root digest information stored in an on-die Read-Only Memory (ROM) of a Central Processing Unit (CPU), wherein the trusted root digest information is not allowed to be modified;
reading mainboard data from the mainboard if the digest information coincides with the trusted root digest information; and
performing a signature verification algorithm with the trusted root data to verify the integrity of the mainboard data.

10. The method of claim 9, wherein the on-die ROM comprises a plurality of fuses for burning candidate trusted root digest information with different priority levels, respectively, and the method further comprises:
adopting a candidate trusted root digest information with the highest priority level burnt in the fuses as the trusted root digest information.

11. The method of claim 9, wherein the signature verification algorithm is based on an asymmetric encryption/decryption algorithm, the mainboard data is encrypted with a private key based on the asymmetric encryption/decryption algorithm, and the trusted root data comprises a public key corresponding to the private key.

12. The method of claim 9, wherein the digest algorithm is performed by a hardware circuit in the CPU.

13. The method of claim 9, wherein the digest algorithm is performed by executing digest instructions stored in the CPU.

14. The method of claim 9, wherein the signature verification algorithm is performed by a hardware circuit in the CPU.

15. The method of claim 9, wherein the signature verification algorithm is performed by executing signature verification instructions stored in the CPU.

16. The method of claim 9, wherein the mainboard data comprises a ucode patch of the CPU, and the said step of reading the trusted root data from the mainboard is performed once a specific instruction is received during the power-up process.
